(19) United States
(12) Patent Application Publication
(10) Pub. No.: US 2009/0250396 A1
(43) Pub. Date: Oct. 8, 2009

(54) DRAINAGE WATER-TREATING METHOD AND DRAINAGE WATER-TREATING APPARATUS

(76) Inventors: Kazuyuki Yamasaki, Hiroshima-ken (JP); Kazuyuki Sakata, Hiroshima-ken (JP); Kazumi Chuhjoh, Kagawa-Ken (JP); Masaki Kataoka, Osaka-Fu (JP)

Correspondence Address: BIRCH STEWART KOLASCH & BIRCH, PO BOX 747, FALLS CHURCH, VA, 22040-0747, US

(21) Appl. No.: 12/303,407

(22) PCT Filed: May 17, 2007
(86) PCT No.: PCT/JP2007/060125

§ 371 Date: Dec. 4, 2008

(30) Foreign Application Priority Data
Jun. 7, 2006 (JP) 2006-157954

(51) Int. Cl. C02F 9/14

(52) U.S. Cl. 210/631; 210/151

(57) ABSTRACT

Drainage water containing organofluorine compounds is introduced into a micro-nano-babble generation tank (1) wherein microorganisms from a microorganism tank (61), a micro-nano bubble auxiliary agent from an auxiliary agent tank (50), a nutrient from a nutrient tank (52) and micro-nano-babbles generated by a micro-nano babble generator (23) are added to the drainage water so as to produce treatment water. The treatment water is fed from the micro-nano babble generation tank (1) to an active carbon tower (4) wherein the organofluorine compounds contained in the treatment water are decomposed with the microorganisms.

### TECHNICAL FIELD

The present invention relates to a drainage water-treating method and a drainage water-treating apparatus for use, for example, not only in semiconductor plants and liquid crystal plants but also in plants for producing or using organofluorine compounds.

### BACKGROUND ART

Organofluorine compounds are chemically stable substances. The organofluorine compounds, in particular, have good properties in terms of heat resistance and chemical resistance. Therefore, the organofluorine compounds are used as surfactants and the like.

However, the organofluorine compounds are chemically stable substances, and therefore hardly decomposed with microorganisms. The organofluorine compounds, for example, perfluorooctane sulfonate (PFOS) and perfluorooctanoate (PFOA) are hardly decomposed in the ecosystem, so that there have been concerns about harmful influence to the ecosystem. Heat decomposition of PFOS or PFOA requires high temperature of about 1000° C. or more due to the chemical stability (see JP 2001-302551 A).

### DISCLOSURE OF THE INVENTION

### Subject to be Solved by the Invention

An object of the present invention is to provide a drainage water-treating method and a drainage water-treating apparatus which can effectively decompose persistent organofluorine compounds with use of microorganisms.

### Means for Solving the Subject

In order to achieve the above object, the present invention provides a drainage water-treating method, comprising the steps of:

adding microorganisms, an auxiliary agent for micro-nano bubble generation and a nutrient as well as micro-nano bubbles to drainage water containing organofluorine compounds in a micro-nano bubble generation tank to produce treatment water; and

feeding the treatment water to an active carbon tower filled with active carbon so as to decompose the organofluorine compounds in the treatment water with the microorganisms.

The micro-nano bubbles herein are defined as air bubbles having a diameter of 10 μm to around several hundred nm. The auxiliary agent for micro-nano bubble generation refers to an auxiliary agent which can maintain the state of stable generation of micro-nano bubbles. The nutrient refers to a nutrient necessary for activating microorganisms. The organofluorine compounds refer to perfluorooctane sulfonate (PFOS) and perfluorooctanoate (PFOA), for example.

According to the drainage water-treating method of the invention, microorganisms, the auxiliary agent for micro-nano bubble generation and the nutrient are added to the drainage water containing organofluorine compounds, while the micro-nano bubbles are added thereto to produce treatment water in the micro-nano bubble generation tank. The treatment water is fed to an active carbon tower (or column) filled with active carbon so as to decompose the organofluorine compounds in the treatment water with use of the microorganisms. Thus, the microorganisms can be propagated on the active carbon in the active carbon tower which is an immobilization support of the microorganisms, and can be further activated by the micro-nano bubbles and the nutrient. Thereby, the organofluorine compounds can rationally be decomposed and treated. Addition of the auxiliary agent for micro-nano bubble generation to the water allows generating an optimum amount of the micro-nano bubbles which activate the microorganisms.

Thus, persistent organofluorine compounds e.g. PFOS or PFOA can effectively be decomposed with the microorganisms.

The present invention also provides a drainage water-treating apparatus, comprising:

a micro-nano bubble generation tank which houses a micro-nano bubble generator;

a microorganism tank which houses microorganisms and which is connected to the micro-nano bubble generation tank;

an auxiliary agent tank which houses an auxiliary agent for micro-nano bubble generation and which is connected to the micro-nano bubble generation tank;

a nutrient tank which houses a nutrient and which is connected to the micro-nano bubble generation tank; and

an active carbon tower which is filled with active carbon and which is connected to the micro-nano bubble generation tank, wherein

drainage water containing organofluorine compounds is introduced into the micro-nano bubble generation tank, in which the microorganisms from the microorganism tank, the auxiliary agent for micro-nano bubble generation from the auxiliary agent tank and the nutrient from the nutrient tank are added to the drainage water while the micro-nano bubbles are added to the drainage water so as to produce treatment water, and wherein

the treatment water is fed to the active carbon tower so as to decompose the organofluorine compounds in the treatment water with the microorganisms.

The micro-nano bubbles are herein defined as air bubbles having a diameter of 10 μm to around several hundred nm. The auxiliary agent for micro-nano bubble generation refers to an auxiliary agent which can maintain the state of stable generation of micro-nano bubbles. The nutrient refers to a nutrient necessary for activating microorganisms. The organofluorine compounds refer to PFOS or PFOA, for example.

The drainage water-treating apparatus of the invention has the micro-nano bubble generation tank, the microorganism tank, the auxiliary agent tank, the nutrient tank, and the active carbon tower. The drainage water containing organofluorine compounds is introduced into the micro-nano bubble generation tank in which the microorganisms, the auxiliary agent for micro-nano bubble generation and the nutrient are added to the drainage water while the micro-nano bubbles are added thereto to produce treatment water. The treatment water is fed to the active carbon tower so as to decompose the organofluorine compounds in the treatment water by using the microorganisms. Thus, the microorganisms can be propagated on the active carbon in the active carbon tower, which is an immobilization support of the microorganisms, and can be further activated with the micro-nano bubbles and the nutrient. Thereby, the organofluorine compounds can rationally be decomposed and treated. Moreover, addition of the auxiliary agent for micro-nano bubble generation to the water allows generating an optimum amount of the micro-nano bubbles which activate the microorganisms.

Thus, persistent organofluorine compounds e.g. PFOS or PFOA can effectively be decomposed with the microorganisms.

The drainage water-treating apparatus in one embodiment further comprises:

an exhaust gas treatment tank which houses an other micro-nano bubble generator and which is connected to the micro-nano bubble generation tank;

an other microorganism tank which houses microorganisms and which is connected to the exhaust gas treatment tank;

an other auxiliary agent tank which houses an other auxiliary agent for micro-nano bubble generation and which is connected to the exhaust gas treatment tank; and

an other nutrient tank which houses an other nutrient and which is connected to the exhaust gas treatment tank, wherein

the microorganisms from the other microorganism tank, the other auxiliary agent for micro-nano bubble generation from the other auxiliary agent tank and the other nutrient from the other nutrient tank are added to the water introduced into the exhaust gas treatment tank, while micro-nano bubbles are added to the water from the micro-nano bubble generator so as to produce cleaning water, and wherein

the organofluorine compounds in the treatment water are decomposed with the microorganisms in the active carbon tower to generate exhaust gas which is introduced into the exhaust gas treatment tank so as to be treated with the cleaning water.

The drainage water-treating apparatus of the present embodiment includes the exhaust gas treatment tank, the microorganism tank, the auxiliary agent tank and the nutrient tank. The microorganisms, the auxiliary agent for micro-nano bubble generation and the nutrient are added to the water introduced into the exhaust gas treatment tank while micro-nano bubbles are added to the water so as to produce cleaning water. The exhaust gas is treated with the cleaning water, so that fluoride in the exhaust gas can rationally be treated by the activated microorganisms in the cleaning water.

The drainage water-treating apparatus in one embodiment further comprises:

a relay tank which has an aeration section and which is connected to the activated carbon tower and the exhaust gas treatment tank, wherein

the treatment water and the exhaust gas passing through the active carbon tower are introduced into the relay tank to be divided into the treatment water and the exhaust gas, and wherein

the exhaust gas is introduced into the exhaust gas treatment tank.

According to the drainage water-treating apparatus of the embodiment, the treatment water and the exhaust gas can be treated individually and reliably because the treatment water and the exhaust gas passing through the active carbon tower are introduced into the relay tank having the aeration section so as to be separated into the treatment water and the exhaust gas.

In the drainage water-treating apparatus of one embodiment, the exhaust gas treatment tank has:

a lower reservoir section located in a lower part of the exhaust gas treatment tank, housing the other micro-nano bubble generator, and reserving the cleaning water; and

an upper spray section located in an upper part of the exhaust gas treatment tank and spraying the cleaning water pumped up from the lower reservoir section, wherein

the cleaning water sprayed from the upper spray section washes the exhaust gas and is reserved in the lower reservoir section before being pumped up again to the upper spray section.

According to the drainage water-treating apparatus of the embodiment, the cleaning water can be cyclically used between the upper spray section and the lower reservoir section because the cleaning water sprayed from the upper spray section washes the exhaust gas and is reserved in the lower reservoir section before being pumped up again to the upper spray section.

In the drainage water-treating apparatus of one embodiment, a filler is housed in the micro-nano bubble generation tank.

According to the drainage water-treating apparatus of the embodiment, the filler is housed in the micro-nano bubble generation tank, so that the microorganisms activated by the micro-nano bubbles can be fixed to and propagated on the filler.

In the drainage water-treating apparatus of one embodiment, the micro-nano bubble generator is housed in the relay tank.

According to the drainage water-treating apparatus of the embodiment, the microorganisms in the treatment water can be activated in the relay tank and that the activated microorganisms can further decompose the organofluorine compounds remaining in the treatment water because the micro-nano bubble generator is housed in the relay tank.

In the drainage water-treating apparatus of one embodiment, an other filler is housed in the relay tank.

According to the drainage water-treating apparatus of the embodiment, the microorganisms activated with the micro-nano bubbles can be cultivated in the filler as an immobilization support at high concentration because the filler is housed in the relay tank. Thereby, the treatment efficiency of the treatment water can be enhanced.

In the drainage water-treating apparatus of one embodiment, the filler is made of polyvinylidene chloride.

In this case, the polyvinylidene chloride filler has in, for example, a string shape or a ring shape.

According to the drainage water-treating apparatus of the embodiment, activated microorganisms can be cultivated in the polyvinylidene chloride filler at high concentration because the filler is made of polyvinylidene chloride. Thereby, the primary treatment of the organofluorine compounds can be performed.

In the drainage water-treating apparatus of one embodiment, the polyvinylidene chloride filler has a string shape.

According to the drainage water-treating apparatus of the embodiment, a lot of the polyvinylidene chloride fillers can be housed in the micro-nano bubble generation tank and the relay tank because the polyvinylidene chloride filler has a string shape.

In the drainage water-treating apparatus of one embodiment, the treatment water separated from the relay tank is treated with chelating resin.

According to the drainage water-treating apparatus of the embodiment, the low-concentration fluorine contained in the treatment water from the relay tank can be highly treated because the treatment water separated from the relay tank is treated with chelating resin.

In the drainage water-treating apparatus of one embodiment, the filler is made of active carbon.

In this case, the active carbon may be housed in a net bag and a reticulated pipe may be placed between the adjacent net bags, for example.

According to the drainage water-treating apparatus of the embodiment, since the filler is an active carbon, the organofluorine compounds absorbed on the active carbon can be decomposed with the activated microorganisms. In other words, the active carbon can be regenerated by the activated microorganisms.

In the drainage water-treating apparatus of one embodiment, the active carbon is housed in a net bag.

According to the drainage water-treating apparatus of the embodiment, since the active carbon is housed in the net bag, the active carbon placed in the net bags can easily be accommodated in the micro-nano bubble generation tank and the relay tank.

In the drainage water-treating apparatus of one embodiment, a plurality of net bags are provided, and a reticulated pipe is provided between at least one pair of adjacent net bags.

According to the drainage water-treating apparatus of the embodiment, the flow of the water to all the active carbon can be improved to prevent clogging phenomenon from occurring because the reticulated pipe is provided between at least one pair of the adjacent net bags.

In the drainage water-treating apparatus of one embodiment, the treatment water separated from the relay tank is subjected to precipitation treatment with a calcium agent.

According to the drainage water-treating apparatus of the embodiment, the treatment water separated from the relay tank is subjected to the precipitation treatment with a calcium agent, and therefore the high concentration fluoride in the treatment water in the relay tank can be precipitated and treated as harmless calcium fluoride by adding the calcium agent.

In the drainage water-treating apparatus of one embodiment, a filler is housed in the lower reservoir section of the exhaust gas treatment tank.

According to the drainage water-treating apparatus of the embodiment, since the filler is housed in the lower reservoir section of the exhaust gas treatment tank, the microorganisms are propagated on the filler, and thereby the cleaning water which absorbed the organic matter in the exhaust gas can be treated in the lower reservoir section. Specifically, the microorganisms propagated and activated on the filler can decompose the organofluorine compounds in the cleaning water.

In the drainage water-treating apparatus of one embodiment, the filler is made of polyvinylidene chloride.

In this case, the polyvinylidene chloride filler has, for example, a string shape or ring shape.

According to the drainage water-treating apparatus of the embodiment, the filler is made of polyvinylidene chloride, so that activated microorganisms can be cultivated in the polyvinylidene chloride filler at high concentration, and thereby the organofluorine compounds can be treated.

In the drainage water-treating apparatus of one embodiment, the polyvinylidene chloride filler has a string shape.

According to the drainage water-treating apparatus of the embodiment, since the polyvinylidene chloride filler has the string shape, a lot of the polyvinylidene chloride fillers can be housed in the lower reservoir section of the exhaust gas treatment tank.

In the drainage water-treating apparatus of one embodiment, the polyvinylidene chloride filler has a ring shape.

According to the drainage water-treating apparatus of the embodiment, since the polyvinylidene chloride filler has the ring shape, the polyvinylidene chloride filler can easily be housed in the lower reservoir section of the exhaust gas treatment tank.

In the drainage water-treating apparatus of one embodiment, the filler is made of active carbon.

In this case, the active carbon may be contained in a net bag and a reticulated pipe may be placed between the adjacent net bags, for example.

According to the drainage water-treating apparatus of the embodiment, since the filler is an active carbon, the organofluorine compounds absorbed on the active carbon can be decomposed with the activated microorganisms. In other words, the active carbon can be regenerated by the activated microorganisms.

In the drainage water-treating apparatus of one embodiment, the active carbon is housed in a net bag.

According to the drainage water-treating apparatus of the embodiment, since the active carbon is housed in the net bag, the active carbon placed in the net bags can easily be accommodated in the lower reservoir section of the exhaust gas treatment tank.

In the drainage water-treating apparatus of one embodiment, a plurality of net bags are provided, and a reticulated pipe is provided between at least one pair of adjacent net bags.

According to the drainage water-treating apparatus of the embodiment, the flow of the water to all the active carbon can be improved to prevent clogging phenomenon from occurring because the reticulated pipe is provided between at least one pair of the adjacent net bags.

### EFFECTS OF THE INVENTION

According to the drainage water-treating method of the invention, persistent organofluorine compounds can be effectively decomposed with microorganisms. This is because the microorganisms, the auxiliary agent for micro-nano bubble generation and the nutrient as well as the micro-nano bubbles are added to drainage water containing organofluorine compounds so as to produce treatment water in the micro-nano bubble generation tank, and then the treatment water is fed to the active carbon tower filled with active carbon so as to decompose the organofluorine compounds in the treatment water with use of the microorganisms.

According to the drainage water-treating apparatus of the invention, persistent organofluorine compounds can be effectively decomposed with microorganisms. This is because the drainage water-treating apparatus includes the micro-nano bubble generation tank, the microorganism tank, the auxiliary agent tank, the nutrient tank, and the active carbon tower, so that the drainage water containing organofluorine compounds is introduced into the micro-nano bubble generation tank, wherein the microorganisms, the auxiliary agent for micro-nano bubble generation and the nutrient as well as the micro-nano bubbles are added to the drainage water so as to produce treatment water, and then the treatment water is fed to the active carbon tower so as to decompose the organofluorine compounds in the treatment water with use of the microorganisms.

### BRIEF DESCRIPTION OF THE DRAWINGS

FIG. 1 shows a schematic view of a drainage water-treating apparatus in a first embodiment of the invention;

FIG. 2 shows a schematic view of a drainage water-treating apparatus in a second embodiment of the invention;

FIG. 3 shows a schematic view of a drainage water-treating apparatus in a third embodiment of the invention;

FIG. 4 shows a schematic view of a drainage water-treating apparatus in a fourth embodiment of the invention;

FIG. 5 shows a schematic view of a drainage water-treating apparatus in a fifth embodiment of the invention;

FIG. 6 shows a schematic view of a drainage water-treating apparatus in a sixth embodiment of the invention; and

FIG. 7 shows a schematic view of a drainage water-treating apparatus in a seventh embodiment of the invention.

### BEST MODE FOR CARRYING OUT THE INVENTION

Hereinbelow, the present invention will be described in detail in conjunction with embodiments with reference to the drawings.

### First Embodiment

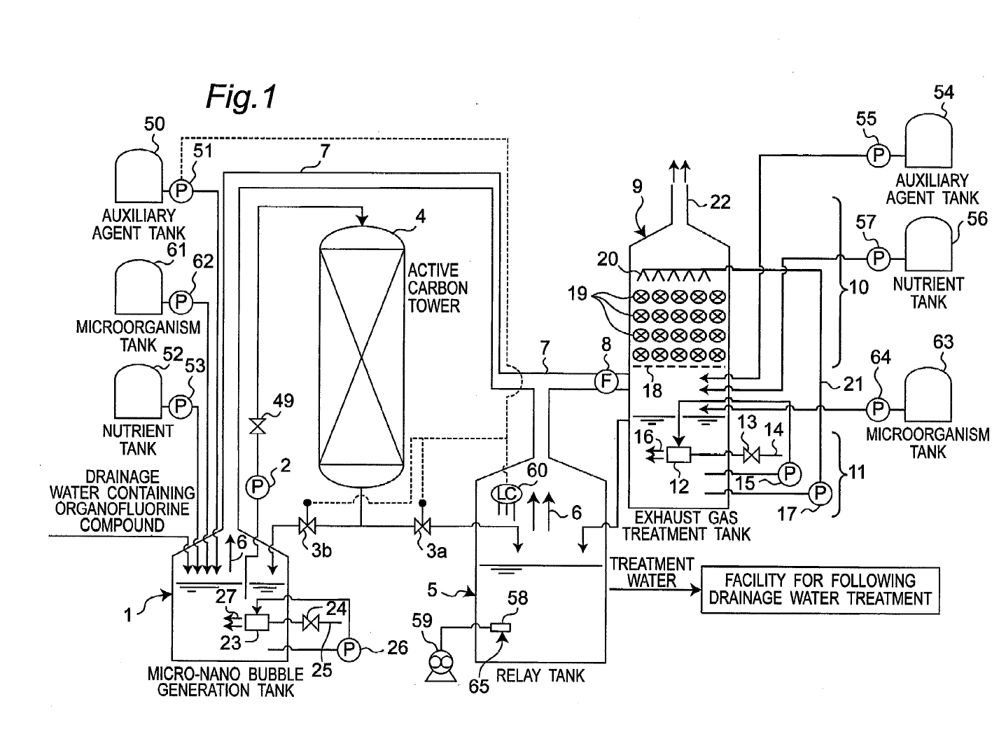

FIG. 1 shows a schematic view of a drainage water-treating apparatus in the first embodiment of the present invention. The drainage water-treating apparatus has a micro-nano bubble generation tank 1 for housing a micro-nano bubble generator 23, a microorganism tank 61 for storing microorganisms, an auxiliary agent tank 50 for storing an auxiliary agent for micro-nano bubble generation, a nutrient tank 52 for storing a nutrient, and an active carbon tower 4 filled with active carbon. The micro-nano bubble generation tank 1 is connected to the microorganism tank 61, the auxiliary agent tank 50, the nutrient tank 52 and the active carbon tower 4.

Drainage water containing organofluorine compounds is introduced into the micro-nano bubble generation tank 1. Then, the microorganisms from the microorganism tank 61, the auxiliary agent for micro-nano bubble generation from the auxiliary agent tank 61 and the nutrient from the nutrient tank 52 are added to the drainage water. The micro-nano bubbles are also added to the drainage water to produce treatment water.

The treatment water is fed from the micro-nano bubble generation tank 1 to the active carbon tower 4, so that the organofluorine compounds in the treatment water are decomposed with the microorganisms.

A microorganism tank pump 62 is connected to the microorganism tank 61 so as to pump out the microorganisms to the micro-nano bubble generation tank 1. An auxiliary agent tank pump 51 is connected to the auxiliary agent tank 50 so as to pump out the auxiliary agent for micro-nano bubble generation to the micro-nano bubble generation tank 1. A nutrient tank pump 53 is connected to the nutrient tank 52 so as to pump out the nutrient to the micro-nano bubble generation tank 1. A micro-nano bubble generation tank pump 2 is connected to the micro-nano bubble generation tank 1 so as to pump out the treatment water to the active carbon tower 4.

The microorganisms may be of those contained in general biologically treatment water or of those particularly excellent in decomposing organofluorine compounds. Further, the microorganisms may be of any type without any limitations.

The microorganisms added from the microorganism tank 61 may be cluster of microorganisms or may be those existing in liquid, depending on the microorganisms to use.

The auxiliary agent for micro-nano bubble generation can stably maintain the generation state of micro-nano bubbles. Specifically, the auxiliary agent for micro-nano bubble generation generates optimal micro-nano bubbles and activates all microorganisms existing.

The nutrient refers to a nutrient which is necessary to activate microorganisms and which contains nitrogen and phosphorus as main ingredients, and a minute amount of potassium, magnesium and calcium.

The micro-nano bubble generator 23 is connected to an air suction pipe 25. The air suction pipe 25 is connected to a valve 24 for adjusting the air suction amount. The micro-nano bubble generator 23 is connected to a circulating pump 26. The circulating pump 26 feeds the water in the micro-nano bubble generation tank 1 to the micro-nano bubble generator 23.

The micro-nano bubble generator 23 is fed with the water by the circulating pump 26. Simultaneously, the micro-nano bubble generator 23 sucks air through the air suction pipe 25 so as to create a ultra-high-speed spiral flow of water with air. This results in generation of micro-nano bubbles after the lapse of a definite period of time.

The circulating pump 26 feeds the water into the micro-nano bubble generator 23 at a required pressure. The required pressure is 1.5 kg/cm² or more, at which feeding the water leads to efficient generation of micro-nano bubbles.

As the micro-nano bubble generator 23, any commercially available products may be adopted without limitation to manufacturers. However, specifically, they are made by Nanoplanet Research Institute Corporation, Aura Tec Corporation, Nomura Electronics Co., Ltd or the like. Further, an example of other adoptable products is a micro bubble water producing machine which is made by Seika Corporation or Shigenkaihatsu Corporation. These products may be selected depending on the application purposes.

The micro-nano bubbles are defined as air bubbles having a diameter of 10 μm to several hundred nm. Normal-sized bubbles (air bubbles) ascend in water, reach the top of water, and finally burst to disappear. Micro bubbles are defined as air bubbles which have the size of 10 to several dozen μm. Micro bubbles are reduced in size underwater, and disappear (completely dissolved) in the end. Nano bubbles are defined as air bubbles having a diameter of several hundred nm or less. Nano bubbles can exist in water permanently. The micro-nano bubbles are bubbles that the micro bubbles and the nano bubbles are mixed together.

Inside the micro-nano bubble generation tank 1, addition of the auxiliary agent for micro-nano bubble generation allows micro-nano bubbles to be optimally generated from the micro-nano bubble generator 23.

A water stream 27 is generated by fine bubbles discharged from the micro-nano bubble generator 23, as shown in FIG. 1. The water stream 27 becomes a circulating water stream in the micro-nano bubble generation tank 1. The circulating water stream agitates the content of the micro-nano bubble generation tank 1. Specifically, the water stream 27 mixes the drainage water containing organofluorine compounds, the auxiliary agent for micro-nano bubble generation, the microorganisms and the nutrient. The microorganisms activated with the micro-nano bubbles are further activated by adding the nutrient.

A flow rate of the water, which has been treated in the micro-nano bubble generation tank 1, is adjusted by a valve 49, while the treatment water is introduced into the upper part of the active carbon tower 4 by the micro-nano bubble generation tank pump 2.

Active carbon filled in the active carbon tower 4 is, for example, coconut shell active carbon or coal-based active carbon. Whether the coconut shell active carbon is selected or the coal-based active carbon is selected may be determined on the basis of types and shapes of the active carbon or the introduction amount of the treatment water, through conduction of treatment experiments.

The microorganisms activated by micro-nano bubbles are propagated on the active carbon in the active carbon tower 4. These microorganisms decompose the organofluorine compounds. Decomposition of the organofluorine compounds generates gas containing fluoride, which flows out of the lower part of the active carbon tower 4 together with the treatment water.

In the case where microorganisms do not sufficiently propagate on the active carbon, continuously introducing water into the active carbon may deteriorate the capability of the active carbon to absorb the organic matter. However, the active carbon is regenerated when the activity ratio of the microorganisms propagating on the active carbon is high, so that the organic matter absorbed on the active carbon is decomposed.

Conventionally, in water purification plants for water service, an organic load of influent water is low, and therefore the active carbon has been naturally regenerated by microorganisms. On the other hand, in drainage water, since an organic load is rather high, the active carbon has been rarely regenerated.

In the present invention, microorganisms in water to be treated are activated by using the micro-nano bubbles, so that the microorganisms are propagated on the active carbon as an immobilization support. As a consequence, the active carbon having the propagated microorganisms becomes what is called a biological active carbon. The biological active carbon is strong and has automatic regeneration capability, even if drainage water has a high organic load. This requires no regeneration of the active carbon in the active carbon tower 4, which reduces maintenance costs and running costs.

An exhaust gas treatment tank 9 is connected to the micro-nano bubble generation tank 1 via a duct 7. A relay (or transit) tank 5 is connected to the active carbon tower 4 and the exhaust gas treatment tank 9. In other words, the relay tank 5 is connected to the exhaust gas treatment tank 9 via the duct 7 while the relay tank 5 is connected to the active carbon tower 4 via a pipe.

The active carbon tower 4 has a branch line on the downstream side. One end of the branch line is connected to the relay tank 5 via an automatic valve 3a. The other end of the branch line is connected to the micro-nano bubble generation tank 1 via an automatic valve 3b.

In the case where the treatment water has high water quality and the organofluorine compounds in the treatment water are decomposed, the automatic valve 3a is opened and the automatic valve 3b is closed, so that the treatment water together with the exhaust gas containing fluoride is discharged from the active carbon tower 4 and introduced into the relay tank 5.

Specifically, when the treatment water introduced into the relay tank 5 has poor water quality, the treatment water bubbles because the organofluorine compounds therein are not sufficiently decomposed in the case of the treatment water having poor water quality. The bubbles go up in the relay tank 5 and end up touching a pole bolt 60 in the relay tank 5. As the result, the automatic valve 3a is closed and the automatic valve is opened.

On the contrary, when the treatment water has high water quality and therefore the organofluorine compounds are decomposed, the treatment water in the relay tank 5 does not bubble. As the result, the automatic valve 3a is opened and the automatic valve 3b is closed, so that the treatment water and the exhaust gas are sequentially introduced into the relay tank 5.

The relay tank 5 has an aeration section 65. The aeration section 65 is composed of an air diffusing pipe 58 and a blower 59. The air diffusing pipe 58 exists in the relay tank 5. The blower 59 sends air to the air diffusing pipe 58. The treatment water is bubbled by the aeration section 65.

The treatment water coming out of the relay tank is treated in a facility for following drainage water treatment (or drainage water-treatment system in the next stage), depending on the content (i.e., water quality) of the treatment water. In most cases, drainage water containing fluorine is treated in the facility for following drainage water treatment.

The exhaust gases 6 containing fluoride (shown by an arrow) in the micro-nano bubble generation tank 1 and the relay tank 5 are introduced into the exhaust gas treatment tank 9 via a duct 7 by using a fan 8.

Thus, the treatment water and the exhaust gas, which have passed through the active carbon tower 4, are introduced into the relay tank 5, so that they are separated into the treatment water and the exhaust gas. The exhaust gas is introduced into the exhaust gas treatment tank 9.

The exhaust gas treatment tank 9 houses the micro-nano bubble generator 12. The exhaust gas treatment tank 9 is connected to a microorganism tank 63 for storing microorganisms, an auxiliary agent tank 54 for storing an auxiliary agent for micro-nano bubble generation, and a nutrient tank 56 for storing a nutrient. The microorganism tank 63, the auxiliary agent tank 54, and the nutrient tank 56 have the same structures as the microorganism tank 61, the auxiliary agent tank 50 and the nutrient tank 52. Therefore, the explanation thereof is omitted.

The microorganism tank 63 is connected to a microorganism tank pump 64 which pumps out the microorganisms to the exhaust gas treatment tank 9. The auxiliary agent tank 54 is connected to an auxiliary agent tank pump 55 which pumps out the auxiliary agent for micro-nano bubble generation to the exhaust gas treatment tank 9. The nutrient tank 56 is connected to a nutrient tank pump 57 which pumps out the nutrient to the exhaust gas treatment tank 9.

The microorganisms from the microorganism tank 63, the auxiliary agent for micro-nano bubble generation from the auxiliary agent tank 54 and the nutrient from the nutrient tank 56 are added to the water introduced to the exhaust gas treatment tank 9. Also, micro-nano bubbles generated by the micro-nano bubble generator 12 are added to the water. In this way, cleaning water is obtained.

The microorganisms decompose the organofluorine compounds to generate exhaust gas in the treatment water within the active carbon tower 4. The exhaust gas is introduced into the exhaust gas treatment tank 9 so as to be treated by the cleaning water.

The exhaust gas treatment tank 9 has a lower reservoir section 11 located in the lower part thereof and an upper spray section 10 located in the upper part thereof.

The lower reservoir section 11 houses the micro-nano bubble generator 12 and reserves the cleaning water. The upper spray section 10 sprays the cleaning water which is pumped up from the lower reservoir section 11.

The cleaning water sprayed from the upper spray section 10 washes the exhaust gas. Then, the cleaning water is reserved in the lower reservoir section 11 before being pumped up again to the upper spray section 10 via a spray pump 17.

The upper spray section 10 has a porous plate 18, a plastic filler 19 (e.g., brand name “Tellerette”), and a water spray nozzles 20 in this order from the lower side to the upper side. An exhaust outlet 22 is provided with the upper spray section 10 which is located above the water spray nozzle 20.

The exhaust gas containing fluoride flows into the exhaust gas treatment tank 9 from the duct 7 provided between the upper spray section 10 and the lower reservoir section 11. The exhaust gas is then washed with the cleaning water sprayed from the water spray nozzle 20, and thereafter discharged from the exhaust outlet 22.

The micro-nano bubble generator 12 is housed in the lower reservoir section 11. The micro-nano bubble generator 12 has the same structure as the micro-nano bubble generator 23. Therefore, the explanation thereof is omitted.

The micro-nano bubble generator 12 is connected to an air suction pipe 14. The air suction pipe 14 is connected to a valve 13 which adjusts the air suction amount. The micro-nano bubble generator 12 is connected to a circulating pump 15 which feeds the water in the exhaust gas treatment tank 9 to the micro-nano bubble generator 12.

The micro-nano bubble generator 12 is fed with the water by the circulating pump 15. At that time, the micro-nano bubble generator 12 sucks air through the air suction pipe 14 so as to create an ultra-high-speed spiral flow of the water with air. This results in generation of micro-nano bubbles after the lapse of a definite period of time.

Inside the exhaust gas treatment tank 9, optimal micro-nano bubbles are generated from the micro-nano bubble generator 12 by adding the auxiliary agent for micro-nano bubble generation after the lapse of a definite period of time.

A water stream 16 is generated by fine bubbles discharged from the micro-nano bubble generator 12. The water stream 16 becomes a circulating water stream in the exhaust gas treatment tank 9, which stream agitates the content of the exhaust gas treatment tank 9. Specifically, the water stream 16 mixes the drainage water containing organofluorine compounds, the auxiliary agent for micro-nano bubble generation, the microorganisms and the nutrient. The microorganisms activated with the micro-nano bubbles are further activated by adding the nutrient.

The cleaning water in the lower reservoir section 11 is sprayed from the water spray nozzle 20 in the upper spray section 10 by the spray pump 17 via a cleaning water pipe 21.

In comparison between cleaning water containing micro-nano bubbles and cleaning water containing no micro-nano bubbles, it has been confirmed through experiments that the cleaning water containing micro-nano bubbles has a higher removal rate of the organofluorine compounds than the cleaning water containing no micro-nano bubbles.

For the reason thereof, it is thought that gas in the cleaning water containing micro-nano bubbles increases the cleaning effect on fouling components.

Therefore, when an evaporable or easily gasified organofluorine compound is generated, the compound is absorbed onto cleaning water and is decomposed with the microorganisms activated with micro-nano bubbles in the lower reservoir section 11.

After start of operation, the cleaning water in the exhaust gas treatment tank 9 evaporates or blows out through the exhaust outlet 22, so that the cleaning water decreases. A ball tap (not shown) is provided for automatically feeding makeup water so as to maintain the fluid level in the lower reservoir section 11. The exhaust gas containing fluoride treated in the exhaust gas treatment tank 9 dissolves in cleaning water, so that the cleaning water becomes drainage water containing fluorine. The drainage water containing fluorine is treated in a facility for following drainage-water-treatment.

Description is now given on a drainage water-treating method with use of the above-structured drainage water-treating apparatus.

Microorganisms, an auxiliary agent for micro-nano bubble generation and a nutrient are added to drainage water containing organofluorine compounds in the micro-nano bubble generation tank 1. Also, micro-nano bubbles are added thereto. In this way, treatment water is produced.

The treatment water is then fed from the micro-nano bubble generation tank 1 to the active carbon tower 4, which is filled with active carbon, so that the microorganisms decompose the organofluorine compounds in the treatment water.

Once again, the above-structured drainage water-treating apparatus has the micro-nano bubble generation tank 1, the microorganism tank 61, the auxiliary agent tank 50, the nutrient tank 52 and the active carbon tower 4. The drainage water containing organofluorine compounds is introduced into the micro-nano bubble generation tank 1, where the microorganisms, the auxiliary agent for micro-nano bubble generation and the nutrient are added to the drainage water while the micro-nano bubbles are also added thereto. Thereby, treatment water is produced. The treatment water is fed from the micro-nano bubble generation tank 1 to the active carbon tower 4, so that the microorganisms decompose the organofluorine compounds in the treatment water. The microorganisms can be propagated on the active carbon in the active carbon tower 4, which is an immobilization support of the microorganisms, and can be further activated by the micro-nano bubbles and the nutrient. Therefore, the organofluorine compounds can rationally be decomposed. Moreover, addition of the auxiliary agent for micro-nano bubble generation allows generating an optimum amount of the micro-nano bubbles which activate the microorganisms.

Thus, persistent organofluorine compounds, such as perfluorooctanesulfonic acid (PFOS) and perfluorooctanoic acid (PFOA)), can effectively be decomposed with the microorganisms.

Again, the drainage water-treating apparatus also has the exhaust gas treatment tank 9, the microorganism tank 63, the auxiliary agent tank 54, and the nutrient tank 56. The microorganisms, the auxiliary agent for micro-nano bubble generation and the nutrient are added to the water introduced into the exhaust gas treatment tank 9, while the micro-nano bubbles are also added thereto. In this way, cleaning water is produced. The exhaust gas is treated with the cleaning water. Thus, fluoride in the exhaust gas can rationally be treated with the activated microorganisms in the cleaning water.

The treatment water and the exhaust gas passing through the active carbon tower 4 are introduced into the relay tank 5 having the aeration section 65 and are separated into the treatment water and the exhaust gas. Thus, the treatment water and the exhaust gas can be treated individually and reliably.

The cleaning water sprayed from the upper spray section 10 washes the exhaust gas and is then reserved in the lower reservoir section 11 before being pumped up again to the upper spray section 10. Thus, the cleaning water can be cyclically used between the upper spray section 10 and the lower reservoir section 11.

### Second Embodiment

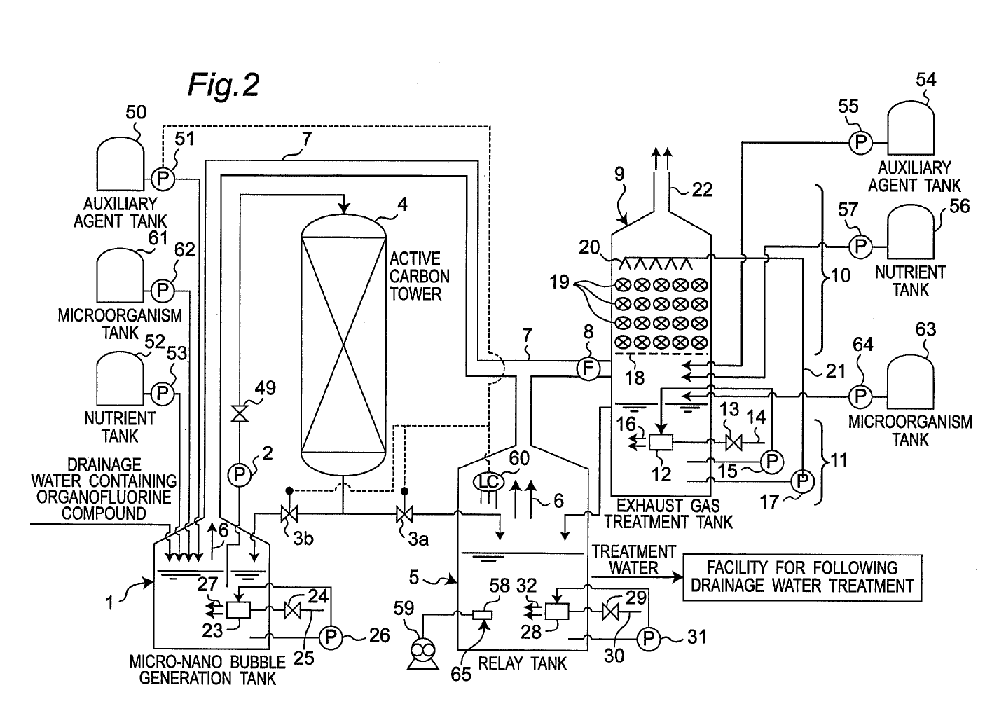

FIG. 2 shows a drainage water-treating apparatus in the second embodiment of the invention. The second embodiment is different from the first embodiment shown in FIG. 1 in the point that a micro-nano bubble generator 28 is housed in the relay tank 5. In the second embodiment, component members identical to those in the first embodiment are designated by identical reference numerals, and the explanation thereof is omitted.

The micro-nano bubble generator 28 has the same structure as the micro-nano bubble generator 23 in the first embodiment shown in FIG. 1. Therefore, the explanation thereof is omitted.

The micro-nano bubble generator 28 is connected to an air suction pipe 30. The air suction pipe 30 is connected to a valve 29 for adjusting the air suction amount. The micro-nano bubble generator 28 is connected to a circulating pump 31 for feeding the water in the relay tank 5 to the micro-nano bubble generator 28.

The micro-nano bubble generator 28 is fed with the water by the circulating pump 31. Simultaneously, the micro-nano bubble generator 28 sucks air through the air suction pipe 30 so as to create an ultra-high-speed spiral flow of the water with air. This results in generation of micro-nano bubbles after the lapse of a definite period of time.

Inside the relay tank 5, optimal micro-nano bubbles are generated from the micro-nano bubble generator 28 by adding the auxiliary agent for micro-nano bubble generation after the lapse of a definite period of time.

A water stream 32 is generated by fine bubbles discharged from the micro-nano bubble generator 28. The water stream 32 becomes a circulating water stream in the relay tank 5, which stream agitates the content of the relay tank 5. Specifically, the water stream 32 mixes the drainage water containing organofluorine compounds, the auxiliary agent for micro-nano bubble generation, the microorganisms and the nutrient. The microorganisms activated with the micro-nano bubbles are further activated by adding the nutrient.

In comparison between treatment water containing micro-nano bubbles and treatment water not containing micro-nano bubbles, it has been confirmed through experiments that the treatment water containing micro-nano bubbles has a higher removal rate of the organofluorine compounds than the treatment water containing no micro-nano bubbles.

This is because the treatment water containing micro-nano bubbles activates the microorganisms and decomposes existing organofluorine compound.

The micro-nano bubble generator 28 needs air to generate micro-nano bubbles. The required amount of air is obtained through the valve 29 and the air suction pipe 30. The treatment water from the relay tank 5 is treated in a following treatment facility, depending on the water quality.

The micro-nano bubble generator 28 is housed in the relay tank 5. Therefore, the microorganisms in the treatment water can be activated in the relay tank 5. Further, the activated microorganisms can decompose the organofluorine compounds remaining in the treatment water.

### Third Embodiment

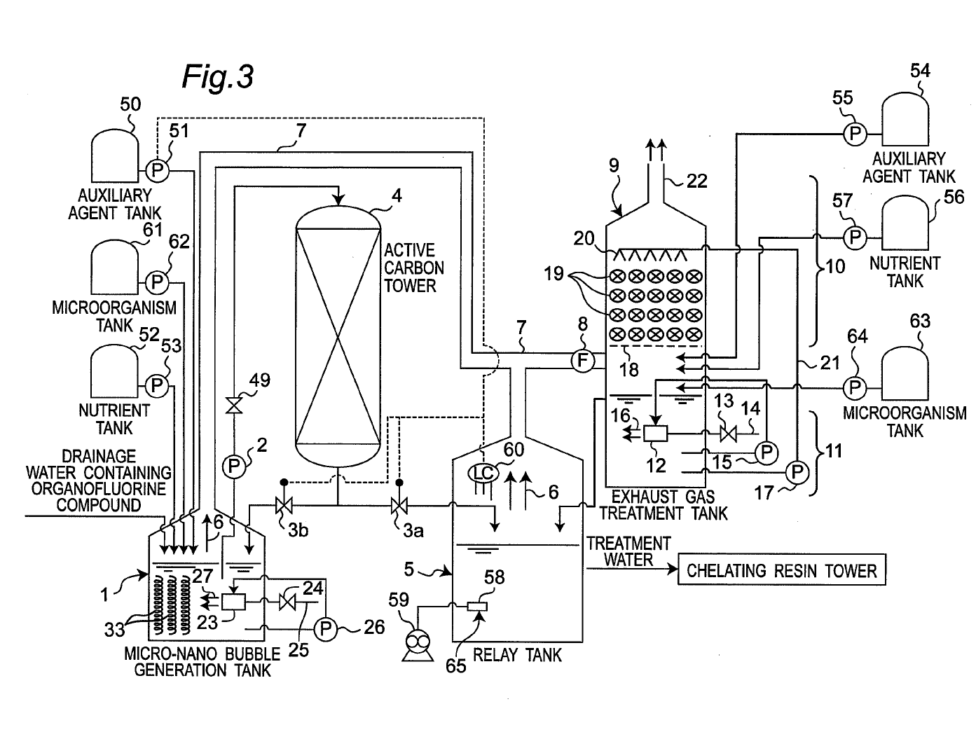

FIG. 3 shows a drainage water-treating apparatus in the third embodiment of the invention. The third embodiment is different from the first embodiment shown in FIG. 1 in the point that a string-shaped polyvinylidene chloride filler 33, as a filler, is housed in the micro-nano bubble generation tank 1. Further, the treatment water separated from the relay tank 5 is treated with chelating resin in a chelating resin tower. In the third embodiment, component members identical to those in the first embodiment are designated by identical reference numerals, and the explanation thereof is omitted.

Since the string-shaped polyvinylidene chloride filler 33 is housed in the micro-nano bubble generation tank 1, the microorganisms activated with the micro-nano bubbles can be fixed to and propagated on the string-shaped polyvinylidene chloride filler 33. Moreover, activated microorganisms can be cultivated at high concentration on the string-shaped polyvinylidene chloride filler 33, and thereby primary treatment of the organofluorine compounds can be performed. Moreover, a lot of the string-shaped polyvinylidene chloride filler 33 can be housed in the micro-nano bubble generation tank 1.

The treatment water separated from the relay tank is treated with chelating resin, so that the low-concentration fluorine in the treatment water within the relay tank 5 can be highly treated with the chelating resin.

### Fourth Embodiment

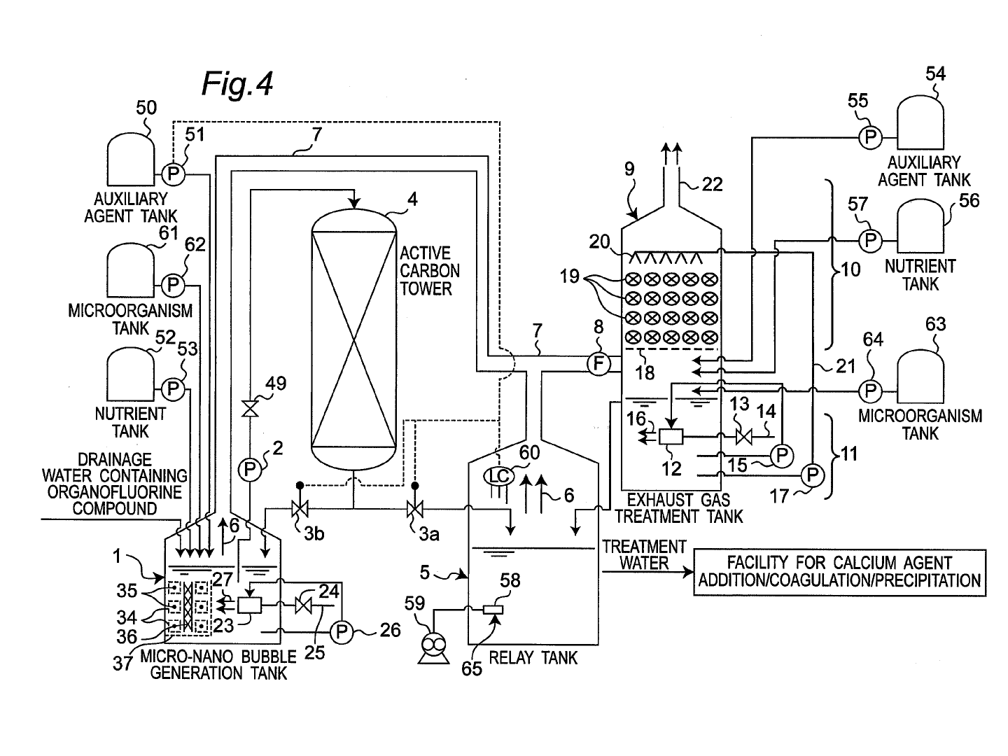

FIG. 4 shows a drainage water-treating apparatus in the fourth embodiment of the invention. The fourth embodiment is different from the first embodiment shown in FIG. 1 in the point that an active carbon 35, as a filler, is housed in the micro-nano bubble generation tank 1. Further, the treatment water separated from the relay tank 5 is subjected to precipitation treatment with a calcium agent in a calcium agent addition/coagulation/precipitation facility. In the fourth embodiment, component members identical to those in the first embodiment are designated by identical reference numerals, and the explanation thereof is omitted.

The active carbon 35 is housed in a plurality of the net bags 34. A reticulated pipe 36 is provided between at least one pair of the adjacent net bags 34. The net bag 34 and the reticulated pipe 36 are housed in a porous plate 37 placed within the micro-nano bubble generation tank 1.

Thus, the organofluorine compounds absorbed on the active carbon 35 can be decomposed with activated microorganisms. In other words, the active carbon 35 can be regenerated by the activated microorganisms. Since the active carbon 35 is housed in the net bag 34, the active carbon 35 can easily be housed by each bag in the micro-nano bubble generation tank 1. Since a reticulated pipe 36 is provided between at least one pair of the adjacent net bags 34, the water smoothly flows to all the active carbon 35 and prevents the clogging phenomenon from occurring.

The treatment water separated from the relay tank 5 is subjected to the precipitation treatment by using a calcium agent. The high concentration fluoride in the treatment water in the relay tank 5 is precipitated by adding the calcium agent and can be treated as harmless calcium fluoride.

### Fifth Embodiment

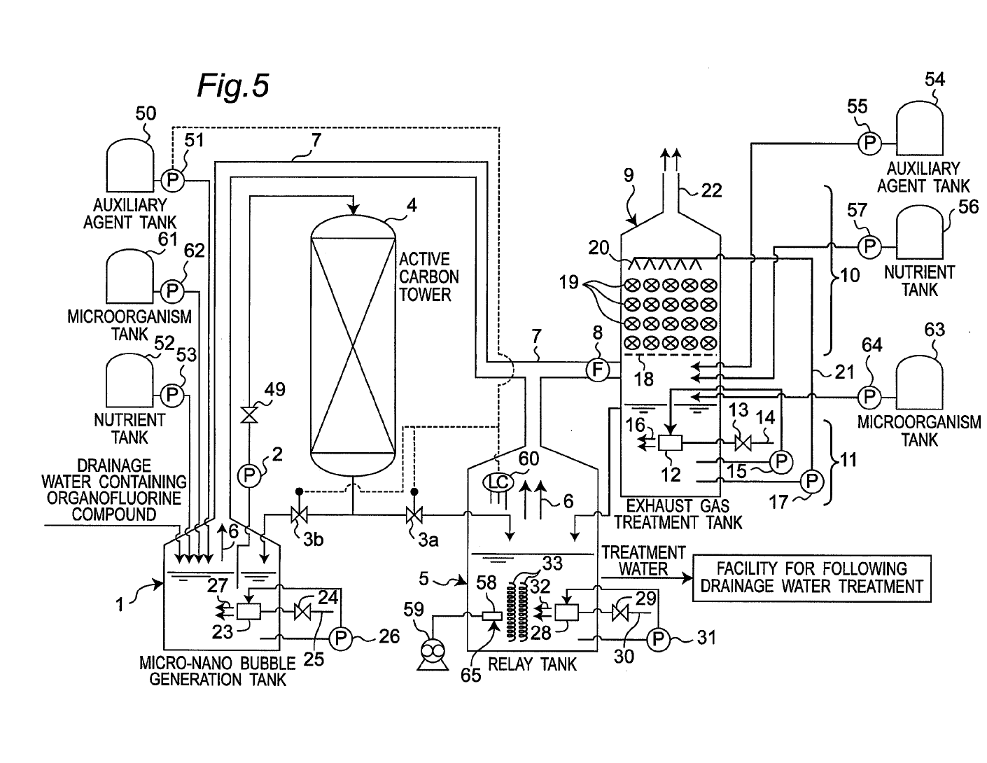

FIG. 5 shows a drainage water-treating apparatus in the fifth embodiment of the invention. The fifth embodiment is different from the first embodiment shown in FIG. 1 in the point that the micro-nano bubble generator 28 is housed in the relay tank 5. Further, a string-shaped polyvinylidene chloride filler 33, as a filler, is housed in the relay tank 5. In the fifth embodiment, component members identical to those in the first embodiment are designated by identical reference numerals, and the explanation thereof is omitted.

The micro-nano bubble generator 28 has the same structure as the micro-nano bubble generator 23 in the first embodiment shown in FIG. 1, and therefore the explanation thereof is omitted.

The micro-nano bubble generator 28 is connected to an air suction pipe 30. The air suction pipe 30 is connected to a valve 29 for adjusting the air suction amount. The micro-nano bubble generator 28 is also connected to a circulating pump 31 for feeding the water in the relay tank 5 to the micro-nano bubble generator 28.

The micro-nano bubble generator 28 is fed with the water by the circulating pump 31. Simultaneously, the micro-nano bubble generator 28 sucks air through the air suction pipe 30 so as to create an ultra-high-speed spiral flow of the water with air. This results in generation of micro-nano bubbles after the lapse of a definite period of time.

Inside the relay tank 5, optimal micro-nano bubbles are generated from the micro-nano bubble generator 28 by adding the auxiliary agent for micro-nano bubble generation after the lapse of a definite period of time.

A water stream 32 is generated by fine bubbles discharged from the micro-nano bubble generator 28. The water stream 32 becomes a circulating water stream in the relay tank 5, which stream agitates the content of the relay tank 5. Specifically, the water stream 32 mixes the drainage water containing organofluorine compounds, the auxiliary agent for micro-nano bubble generation, the microorganisms and the nutrient. The microorganisms activated with the micro-nano bubbles are further activated by adding the nutrient.

In comparison between treatment water containing micro-nano bubbles and treatment water not containing micro-nano bubbles, it has been confirmed through experiments that the treatment water containing micro-nano bubbles has a higher removal rate of the organofluorine compounds than the treatment water containing no micro-nano bubbles.

This is because the treatment water containing micro-nano bubbles activates the microorganisms and decomposes existing organofluorine compound.

The micro-nano bubble generator 28 needs air to generate micro-nano bubbles. The required amount of air is obtained through the valve 29 and the air suction pipe 30. The treatment water from the relay tank 5 is treated in a following treatment facility, depending on the water quality.

The micro-nano bubble generator 28 is housed in the relay tank 5. Therefore, the microorganisms in the treatment water can be activated in the relay tank 5. Further, the activated microorganisms can decompose the organofluorine compounds remaining in the treatment water.

Since the string-shaped polyvinylidene chloride filler 33 is housed in the micro-nano bubble generation tank 1, the microorganisms activated with the micro-nano bubbles can be fixed to and propagated on the string-shaped polyvinylidene chloride filler 33. Moreover, activated microorganisms can be cultivated at high concentration on the string-shaped polyvinylidene chloride filler 33, and thereby treatment efficiency of the treatment water can be enhanced. Moreover, a lot of the string-shaped polyvinylidene chloride filler 33 can be housed in the relay tank 5.

### Sixth Embodiment

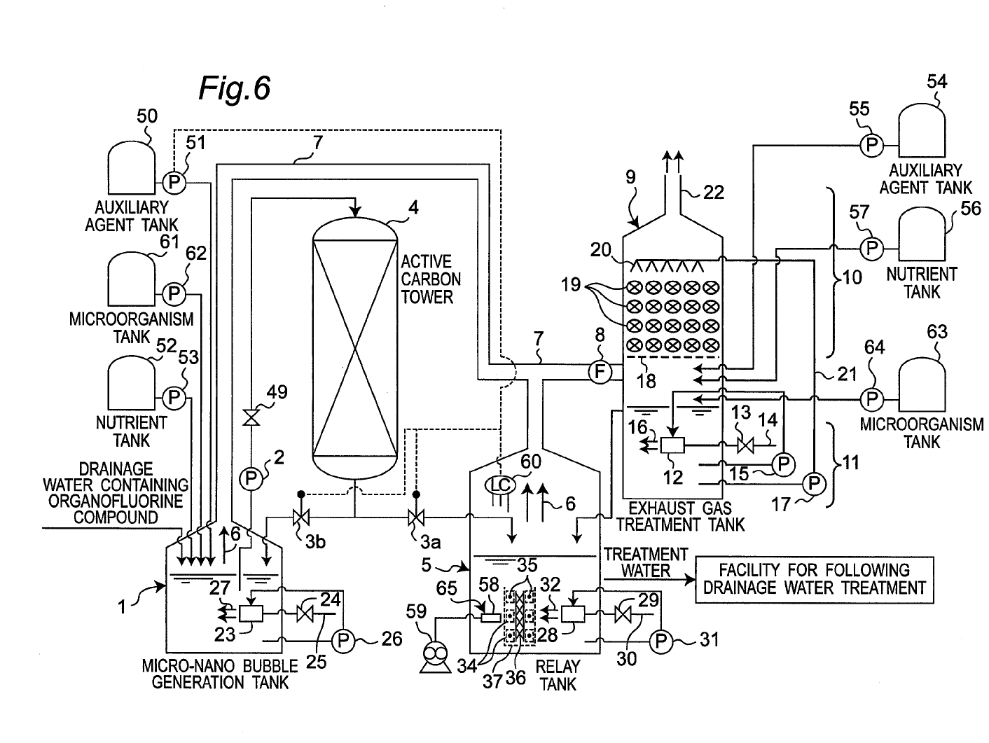

FIG. 6 shows a drainage water-treating apparatus in the sixth embodiment of the invention. The sixth embodiment is different from the first embodiment shown in FIG. 1 in the point that the micro-nano bubble generator 28 is housed in the relay tank 5. Further, an active carbon 35, as a filler, is housed in the relay tank 5. In the sixth embodiment, component members identical to those in the first embodiment are designated by identical reference numerals, and the explanation thereof is omitted.

The micro-nano bubble generator 28 has the same structure as the micro-nano bubble generator 23 in the first embodiment shown in FIG. 1. Therefore, the explanation thereof is omitted.

The micro-nano bubble generator 28 is connected to an air suction pipe 30. The air suction pipe 30 is connected to a valve 29 for adjusting the air suction amount. The micro-nano bubble generator 28 is connected to a circulating pump 31 for feeding the water in the relay tank 5 to the micro-nano bubble generator 28.

The micro-nano bubble generator 28 is fed with the water by the circulating pump 31. Simultaneously, the micro-nano bubble generator 28 sucks air through the air suction pipe 30 so as to create an ultra-high-speed spiral flow of the water with air. This results in generation of micro-nano bubbles after the lapse of a definite period of time.

Inside the relay tank 5, optimal micro-nano bubbles are generated from the micro-nano bubble generator 28 by adding the auxiliary agent for micro-nano bubble generation after the lapse of a definite period of time.

A water stream 32 is generated by fine bubbles discharged from the micro-nano bubble generator 28. The water stream 32 becomes a circulating water stream in the relay tank 5, which stream agitates the content of the relay tank 5. Specifically, the water stream 32 mixes the drainage water containing organofluorine compounds, the auxiliary agent for micro-nano bubble generation, the microorganisms and the nutrient. The microorganisms activated with the micro-nano bubbles are further activated by adding the nutrient.

In comparison between treatment water containing micro-nano bubbles and treatment water not containing micro-nano bubbles, it has been confirmed through experiments that the treatment water containing micro-nano bubbles has a higher removal rate of the organofluorine compounds than the treatment water containing no micro-nano bubbles.

This is because the treatment water containing micro-nano bubbles activates the microorganisms and decomposes existing organofluorine compound.

The micro-nano bubble generator 28 needs air to generate micro-nano bubbles. The required amount of air is obtained through the valve 29 and the air suction pipe 30. The treatment water from the relay tank 5 is treated in a following treatment facility, depending on the water quality.

The micro-nano bubble generator 28 is housed in the relay tank 5. Therefore, the microorganisms in the treatment water can be activated in the relay tank 5. Further, the activated microorganisms can decompose the organofluorine compounds remaining in the treatment water.

The active carbon 35 is housed in a plurality of the net bags 34. A reticulated pipe 36 is provided between at least one pair of the adjacent net bags 34. The net bag 34 and the reticulated pipe 36 are housed in a porous plate 37 placed within the micro-nano bubble generation tank 1.

Therefore, the organofluorine compounds absorbed on the active carbon 35 can be decomposed with activated microorganisms. In other words, the active carbon 35 can be regenerated by the activated microorganisms. Since the active carbon 35 is housed in the net bag 34, the active carbon 35 can easily be housed by each bag in the relay tank 5. Since a reticulated pipe 36 is provided between at least one pair of the adjacent net bags 34, the water smoothly flows to all the active carbon 35 and prevents the clogging phenomenon from occurring.

### Seventh Embodiment

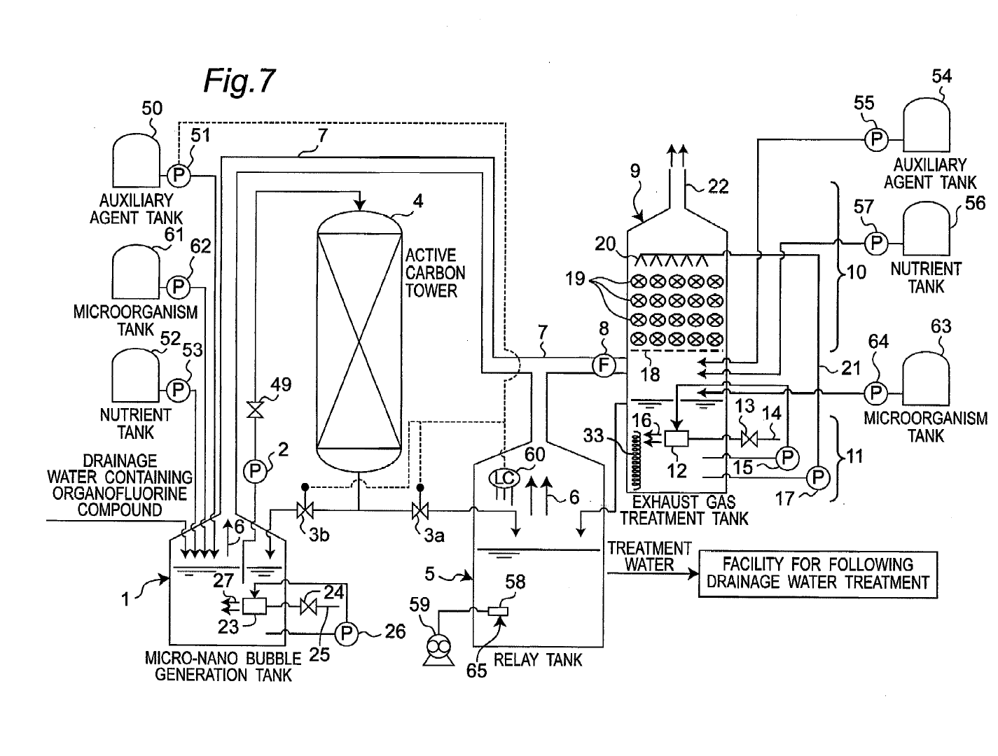

FIG. 7 shows a drainage water-treating apparatus in the seventh embodiment of the invention. The seventh embodiment is different from the first embodiment shown in FIG. 1 in the point that a string-shaped polyvinylidene chloride filler 33, as a filler, is housed in the lower reservoir section 11 of the exhaust gas treatment tank 9. In the seventh embodiment, component members identical to those in the first embodiment are designated by identical reference numerals, and the explanation thereof is omitted.

Since the string-shaped polyvinylidene chloride filler 33 is housed in the exhaust gas treatment tank 9, the microorganisms activated with the micro-nano bubbles can be fixed to and propagated on the string-shaped polyvinylidene chloride filler 33.

Consequently, since the activated microorganisms are increased in concentration, the organic matters can efficiently be treated with the microorganisms, wherein the organic matters are absorbed and transmitted into the cleaning water simultaneously when the exhaust gas containing fluoride is treated by spraying the cleaning water.

In other words, the organofluorine compound gasified in the decomposition process of the organofluorine compound is washed by and absorbed to the cleaning water, and is decomposed with the activated microorganisms propagating on the string-shaped polyvinylidene chloride filler 33.

Moreover, a lot of the string-shaped polyvinylidene chloride filler 33 can be housed in the lower reservoir section 11 of the exhaust gas treatment tank 9.

### Experimental Example

An experimental apparatus corresponding to the first embodiment of FIG. 1 was manufactured. In this experimental apparatus, the capacity of the micro-nano bubble generation tank 1 was about 1 m³. The capacity of the active carbon tower 4 was 2 m³. The capacity of the relay tank 5 was 1 m³. The entire capacity of the exhaust gas treatment tank 9 was about 3 m³. A trial run was conducted for one month in the state that drainage water containing organofluorine compounds and biologically treatment water were introduced into the micro-nano bubble generation tank 1, the active carbon tower 4, the relay tank 5 and the exhaust gas treatment tank 9.

After the trial run, the removal rate of PFOS (perfluorooctane sulfonate) was 92%. The removal rate thereof was obtained by measuring a concentration of PFOS at inlet of the micro-nano bubble generation tank 1 and a concentration of PFOS at outlet of the relay tank 5. Persistent PFOS could be effectively decomposed with microorganisms.

The present invention shall not be limited to the above-stated embodiments. For example, the ring-shaped polyvinylidene chloride filler in the third, fifth or seventh embodiments may be substituted for the string-shaped polyvinylidene chloride filler 33. The ring-shaped polyvinylidene chloride filler can easily be housed in the micro-nano bubble generation tank 1, the relay tank 5 and the exhaust gas treatment tank 9. In the first to seventh embodiments, the string-shaped polyvinylidene chloride filler 33 and/or the active carbon 35 may be used in the micro-nano bubble generation tank 1, the relay tank 5 and/or the exhaust gas treatment tank 9.

1. A drainage water-treating method, comprising the steps of:
adding microorganisms, an auxiliary agent for micro-nano bubble generation and a nutrient as well as micro-nano bubbles to drainage water containing organofluorine compounds in a micro-nano bubble generation tank to produce treatment water; and
feeding the treatment water to an active carbon tower filled with active carbon so as to decompose the organofluorine compounds in the treatment water with the microorganisms.

2. A drainage water-treating apparatus, comprising:
a micro-nano bubble generation tank which houses a micro-nano bubble generator;
a microorganism tank which houses microorganisms and which is connected to the micro-nano bubble generation tank;
an auxiliary agent tank which houses an auxiliary agent for micro-nano bubble generation and which is connected to the micro-nano bubble generation tank;
a nutrient tank which houses a nutrient and which is connected to the micro-nano bubble generation tank; and
an active carbon tower which is filled with active carbon and which is connected to the micro-nano bubble generation tank, wherein
drainage water containing organofluorine compounds is introduced into the micro-nano bubble generation tank, in which the microorganisms from the microorganism tank, the auxiliary agent for micro-nano bubble generation from the auxiliary agent tank and the nutrient from the nutrient tank are added to the drainage water while the micro-nano bubbles are added to the drainage water so as to produce treatment water, and wherein
the treatment water is fed to the active carbon tower so as to decompose the organofluorine compounds in the treatment water with the microorganisms.

3. The drainage water-treating apparatus according to claim 2, comprising:
an exhaust gas treatment tank which houses an other micro-nano bubble generator and which is connected to the micro-nano bubble generation tank;
an other microorganism tank which houses microorganisms and which is connected to the exhaust gas treatment tank;
an other auxiliary agent tank which houses an other auxiliary agent for micro-nano bubble generation and which is connected to the exhaust gas treatment tank; and
an other nutrient tank which houses an other nutrient and which is connected to the exhaust gas treatment tank, wherein
the microorganisms from the other microorganism tank, the other auxiliary agent for micro-nano bubble generation from the other auxiliary agent tank and the other nutrient from the other nutrient tank are added to the water introduced into the exhaust gas treatment tank, while micro-nano bubbles are added to the water from the micro-nano bubble generator so as to produce cleaning water, and wherein
the organofluorine compounds in the treatment water are decomposed with the microorganisms in the active carbon tower to generate exhaust gas which is introduced into the exhaust gas treatment tank so as to be treated with the cleaning water.

4. The drainage water-treating apparatus according to claim 3, comprising:
a relay tank which has an aeration section and which is connected to the activated carbon tower and the exhaust gas treatment tank, wherein
the treatment water and the exhaust gas passing through the active carbon tower are introduced into the relay tank to be divided into the treatment water and the exhaust gas, and wherein
the exhaust gas is introduced into the exhaust gas treatment tank.

5. The drainage water-treating apparatus according to claim 3, wherein
the exhaust gas treatment tank has:
a lower reservoir section located in a lower part of the exhaust gas treatment tank, housing the other micro-nano bubble generator, and reserving the cleaning water; and
an upper spray section located in an upper part of the exhaust gas treatment tank and spraying the cleaning water pumped up from the lower reservoir section, wherein
the cleaning water sprayed from the upper spray section washes the exhaust gas and is reserved in the lower reservoir section before being pumped up again to the upper spray section.

6. The drainage water-treating apparatus according to claim 2, wherein
a filler is housed in the micro-nano bubble generation tank.

7. The drainage water-treating apparatus according to claim 4, wherein
the micro-nano bubble generator is housed in the relay tank.

8. The drainage water-treating apparatus according to claim 7, wherein
an other filler is housed in the relay tank.

9. The drainage water-treating apparatus according to claim 6 or 8, wherein
the filler is made of polyvinylidene chloride.

10. The drainage water-treating apparatus according to claim 9, wherein
the polyvinylidene chloride filler has a string shape.

11. The drainage water-treating apparatus according to claim 4, wherein
the treatment water separated from the relay tank is treated with chelating resin.

12. The drainage water-treating apparatus according to claim 6 or 8, wherein
the filler is made of active carbon.

13. The drainage water-treating apparatus according to claim 12, wherein
the active carbon is housed in a net bag.

14. The drainage water-treating apparatus according to claim 13, wherein
a plurality of net bags are provided, and wherein
a reticulated pipe is provided between at least one pair of adjacent net bags.

15. The drainage water-treating apparatus according to claim 4, wherein
the treatment water separated from the relay tank is subjected to precipitation treatment with a calcium agent.

16. The drainage water-treating apparatus according to claim 5, wherein
a filler is housed in the lower reservoir section of the exhaust gas treatment tank.

17. The drainage water-treating apparatus according to claim 16, wherein
the filler is made of polyvinylidene chloride.

18. The drainage water-treating apparatus according to claim 17, wherein
the polyvinylidene chloride filler has a string shape.

19. The drainage water-treating apparatus according to claim 17, wherein
the polyvinylidene chloride filler has a ring shape.

20. The drainage water-treating apparatus according to claim 16, wherein
the filler is made of active carbon.

21. The drainage water-treating apparatus according to claim 20, wherein
the active carbon is housed in a net bag.

22. The drainage water-treating apparatus according to claim 21, wherein
a plurality of net bags are provided, and wherein
a reticulated pipe is provided between at least one pair of adjacent net bags.
